(19) United States
(12) Patent Application Publication
(10) Pub. No.: US 2012/0079291 A1
(43) Pub. Date: Mar. 29, 2012

(54) DATA BACKUP SYSTEM, STORAGE SYSTEM UTILIZING THE DATA BACKUP SYSTEM, DATA BACKUP METHOD AND COMPUTER READABLE MEDIUM FOR PERFORMING THE DATA BACKUP METHOD

(76) Inventors: Chien-Hung Yang, Taipei City (TW); Chin-Wen Lin, Kaohsiung City (TW)

(21) Appl. No.: 12/891,809

(22) Filed: Sep. 28, 2010

(51) Int. Cl. G06F 1/26

(52) U.S. Cl. 713/300; 711/162

(57) ABSTRACT

A data backup system comprising: a first storage device; a second storage device; a backup controller; and a backup power supplying device; wherein the data is stored to the first storage device in a first mode via main power, and the backup controller receives backup power from the backup power supplying device to move the data stored in the first storage device to the second storage device in a second mode.

### BACKGROUND OF THE INVENTION

1. Field of the Invention

The present application relates to a data backup system, a storage system utilizing the data backup system and related methods, and particularly relates to a data backup system utilizing a backup power supplying device to move data to a non volatile storage when a power cut occurs, a storage system utilizing the data backup system and related methods.

2. Description of the Prior Art

A storage system always needs a data backup system to backup important data to prevent data loss when the power supplied to the storage system suddenly stops (ex. power cut). However, a conventional data backup system tends to provide power to a main memory, which is utilized to backup data, to keep data in the main memory when the main power supplied to the main memory suddenly stops. Also, the conventional data backup system provides power to other devices that control operations of the main memory.

For example, in the U.S. Pat. No. 5,408,421, the cartridge power supply 7 includes a battery for providing battery back-up power to memory 5 and real time clock 6 when a loss of the power supply is detected. Additionally, in the U.S. Pat. No. 5,784,548, the battery backup unit 23 provides power to cache controller 22 and cache DRAM 200.

However, the main memory, and other devices that can perform complex controlling need a lot of power. Thus such backup mechanism consumes a lot of power.

### SUMMARY OF THE INVENTION

One objective of the present invention is to provide a data backup mechanism that can save power consumption.

One embodiment of the present application discloses a data backup system, comprising: a first storage device; a second storage device; a backup controller; and a backup power supplying device; wherein the data is stored to the first storage device in a first mode via main power, and the backup controller receives backup power from the backup power supplying device to move the data stored in the first storage device to the second storage device in a second mode.

Another embodiment discloses a storage system comprising: a main controller; a main power supplying device; a first storage device; a second storage device; a backup controller; and a backup power supplying device; wherein the main controller utilizes main power supplied to the storage system to store data to the main storage device and backups part of the data to the first storage device in a first mode, and the backup controller receives backup power from the backup power supplying device to move the data backup in the first storage device to the second storage device in a second mode.

Another embodiment discloses a data backup method for a data backup system including a first storage device, a second storage device, a backup controller and a backup power supplying, the data backup method comprising: (a) storing data to the first storage device in a first mode via main power; and (b) utilizing the backup controller to receive backup power from the backup power supplying device to move the data stored in the first storage device to the second storage device in a second mode.

Another embodiment discloses a computer readable storage medium including computer program logic encoded thereon that, when executed on a computer system, causes the computer system to produce certified content by performing the operations of: (a) storing data to a first storage device in a first mode via main power; and (b) utilizing a backup controller to receive backup power from a backup power supplying device to backup the data stored in the first storage device to a second storage device in a second mode.

In view of above-mentioned embodiments, the data can be quickly accessed since part of the data is stored to a violate memory that can be quickly accessed. Also, the power consumption can decrease since power is only provided to simple devices when the main power is suddenly cut.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a data backup system according to one embodiment of the present application.

FIG. 2 is a block diagram illustrating a storage system utilizing the data backup system shown in FIG. 1.

FIG. 3 is a flow chart illustrating a data backup method according to one embodiment of the present application.

FIG. 4 is a flow chart illustrating the steps of how the data backup system in FIG. 1 and the storage system in FIG. 2 operates after the main power supplying recovers.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

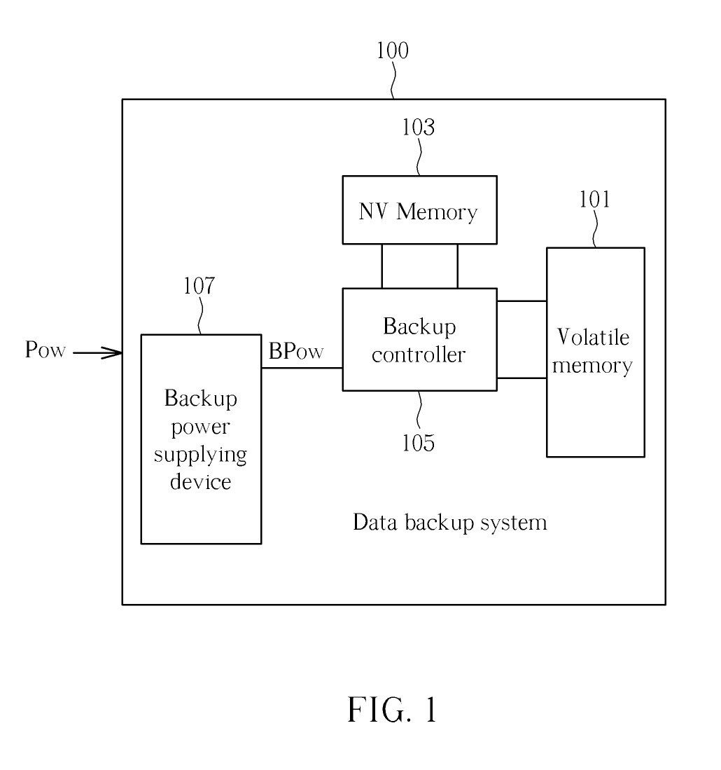

FIG. 1 is a block diagram illustrating a data backup system according to one embodiment of the present application. As shown in FIG. 1, the data backup system 100 includes a volatile storage 101, a non volatile storage 103, a backup controller 105 and a backup power supplying device 107. Additionally, the backup power supplying device 107 can be connected to a device supplying main power Pow via other circuits such as switching circuits, to receive and store power. The backup power supplying device 107 can be a battery or a super capacitor, or other devices that can store power and provide power. In this embodiment, a RAM is taken for example for the volatile storage 101, and a non-violate RAM is taken for example for the non volatile storage 103. However, other storage devices that can not keep data without power can also be utilized as the volatile storage 101, and other storage devices that can keep data without power such as a flash, a SSD and a hard disk can also be utilized as the non volatile storage 103.

In a first mode (i.e. main power POW is continuously provided to the data backup system 100, or called a normal mode), some data is stored to the volatile storage 101. However, if the main power POW can not be provided to the data backup system 100 (a second mode, or called a power cut mode), the backup power supplying device 107 starts to provide the backup power Bpow and the backup controller 105 receives backup power Bpow from the backup power supplying device 107 to move the data stored in the volatile storage 101 to the non volatile storage 103. By this way, the data can be quickly stored to the volatile storage 101 in the normal mode, and can be move and well protected in the non volatile storage 103 in the second mode. However, it should be noted the second mode is not limited to that the main power is cut, the second mode can indicate other situations. For example, the main power is not stable.

In one embodiment, the backup power supplying device 107 only provides the backup power Bpow for a predetermined time (ex. several seconds or minutes) period in the second mode. After the predetermined time period, the backup power supplying device 107 stops providing the backup power Bpow. By this way, the power consumption can be saved. Also, the backup power supplying device 107 can provide backup power until all the data has been moved.

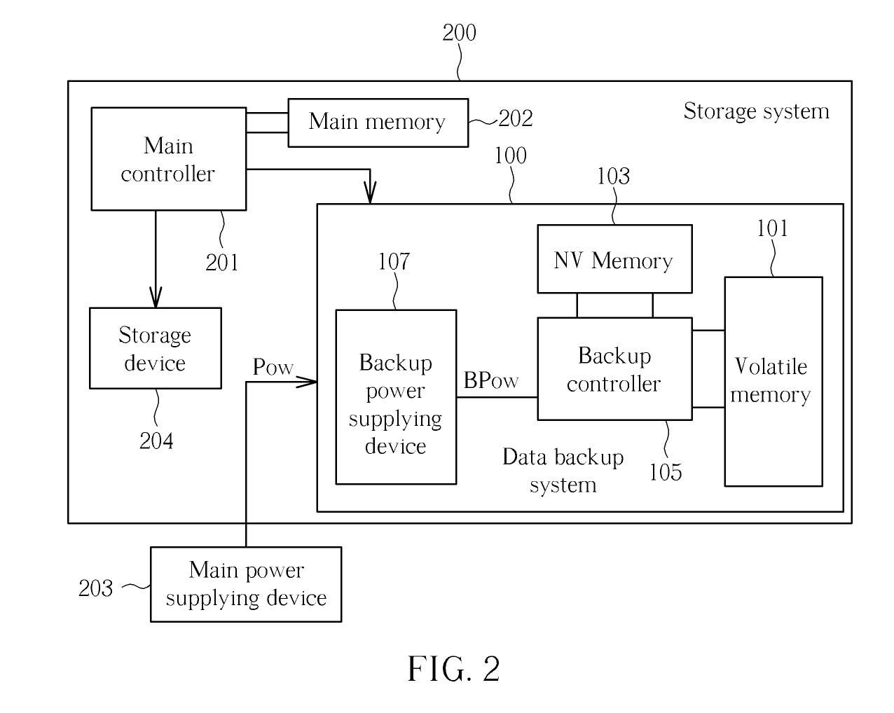

FIG. 2 is a block diagram illustrating a storage system 200 utilizing the data backup system 100 shown in FIG. 1. As shown in FIG. 2, besides the data backup system 101, the storage system 200 further includes a main controller 201, a main memory 202 and a storage device 204.

The main controller 201 utilizes the main power Pow from the main power supplying device 203 to backup data to main memory 202 in the first mode. Then the data backup in the main memory 202 is stored to the storage device 204 such as a hard disk. Also, part of the data stored to the main memory 202 is backup to the volatile storage 101. In view of above-mentioned description, the backup controller 105 receives backup power Bpow from the backup power supplying device 107 to move the data backup in the volatile storage 101 to the non volatile storage 103 in the second mode.

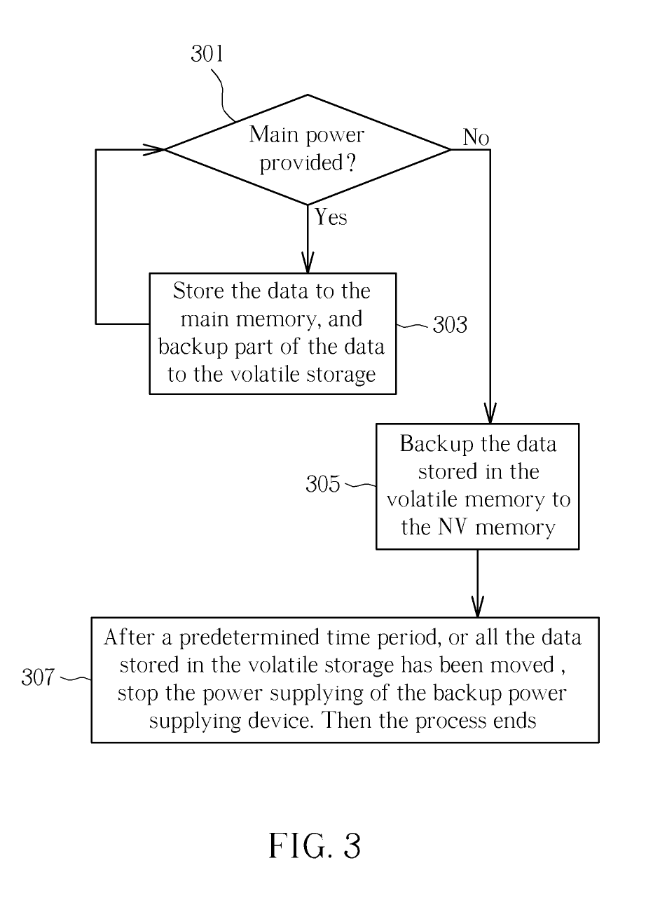

FIG. 3 is a flow chart illustrating a data backup method according to one embodiment of the present application. As shown in FIG. 3, the data backup method includes:

Step 301

Determine if the main power is provided. If yes (the first mode), go to step 303. If not (the second mode), go to step 305.

Step 303

Store the data to the main memory, and backup part of the data to the volatile storage.

Step 305

Utilize the backup controller to receive the backup power from the backup power supplying device to move the data backup in the volatile storage to the non volatile storage.

Step 307

After a predetermined time period, or all the data stored in the volatile storage has been moved, stop the power supplying of the backup power supplying device. Then the process ends.

Other detail steps of the data backup method can be acquired according to the description of the embodiments shown in FIGS. 1 and 2. Thus it is omitted here for brevity. Besides, the steps disclosed in FIG. 3 can be performed via programs stored in a computer readable medium.

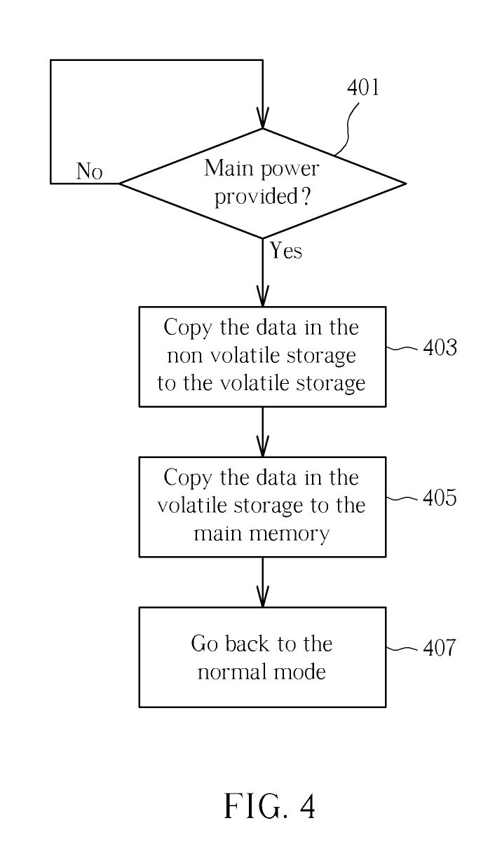

FIG. 4 is a flow chart illustrating the steps of how the data backup system 100 in FIG. 1 and the storage system 200 in FIG. 2 operates after the main power supplying recovers. The steps in FIG. 4 include:

Step 401

Determine if the main power is provided or not. In above mentioned embodiments, the data backup system 100 stops operating after the data stored in the volatile storage is back up to the non volatile storage. Accordingly, if the main power supplying does not recover the data backup system will keep at the same state of non operating. If the main power supplying recovers, following steps 403, 405 and 407 are performed.

Step 403

The backup controller 105 copies the data in the non volatile storage 103 to the volatile storage 101.

Step 405

The main controller 201 copies the data in the volatile storage 101 to the main memory 202.

Step 407

The data in the main memory 202 is stored to the storage device 204 via the main controller 201. That is, the storage system 200 goes back to the operation in the first mode (normal mode).

In view of above-mentioned embodiments, the data can be quickly accessed since part of the data is stored to a violate memory that can be quickly accessed. Also, the power consumption can decrease since power is only provided to simple devices such as the backup controller that perform simple control, the RAM and the NV RAM.

Those skilled in the art will readily observe that numerous modifications and alterations of the device and method may be made while retaining the teachings of the invention.

What is claimed is:

1. A data backup system, comprising:
a first storage device;
a second storage device;
a backup controller; and
a backup power supplying device;
wherein data is stored to the first storage device in a first mode via main power, and the backup controller receives backup power from the backup power supplying device to move the data stored in the first storage device to the second storage device in a second mode.

2. The data backup system of claim 1, wherein the first storage device is a storage device that can not keep data without power, and the second storage device is a storage device that can keep data without power.

3. The data backup system of claim 1, wherein the first mode indicates that the main power is provided to the data backup system, and the second mode indicates that the main power is not provided to the data backup system.

4. The data backup system of claim 1, wherein the backup power supplying device provides the backup power only for a predetermined time period in the second mode.

5. The data backup system of claim 1, wherein the backup power supplying device provides the backup power until all the data stored in the first storage device has been moved to the second storage device.

6. The data backup system of claim 1, after the data backup system switches from the second mode to the first mode, the backup controller copies the data in the second storage device to the first storage device.

7. A storage system, comprising:
a main controller;
a main storage device;
a first storage device;
a second storage device;
a backup controller; and
a backup power supplying device;
wherein the main controller utilizes main power supplied to the storage system to store data to the main storage device and backups part of the data to the first storage device in a first mode, and the backup controller receives backup power from the backup power supplying device to move the data backup in the first storage device to the second storage device in a second mode.

8. The storage system of claim 7, wherein the first storage device is a storage device that can not keep data without power, and the second storage device is a storage device that can keep data without power.

9. The storage system of claim 7, wherein the first mode indicates that the main power is provided to the storage system, and the second mode indicates that the main power is not provided to the storage system.

10. The storage system of claim 7, wherein the backup power supplying device provides the backup power only for a predetermined time period in the second mode.

11. The storage system of claim 7, wherein the backup power supplying device provides the backup power until all the data stored in the first storage device has been moved to the second storage device.

12. The storage system of claim 7, after the storage system switches from the second mode to the first mode, the backup controller copies the data in the second storage device to the first storage device, and the main controller copies the data in the first storage device to the main storage device.

13. A data backup method for a data backup system including a first storage device, a second storage device, a backup controller and a backup power supplying, the data backup method comprising:
(a) storing data to the first storage device in a first mode via main power; and
(b) utilizing the backup controller to receive backup power from the backup power supplying device to move the data stored in the first storage device to the second storage device in a second mode.

14. The data backup method of claim 13, wherein the first storage device is a storage device that can not keep data without power, and the second storage device is a storage device that can keep data without power.

15. The data backup method of claim 13, wherein the first mode indicates that the main power is provided to the data backup system, and the second mode indicates that the main power is not provided to the data backup system.

16. The data backup method of claim 13, wherein the step (b) utilizes the backup power supplying device to provide the backup power only for a predetermined time period in the second mode.

17. The data backup method of claim 13, wherein the step (b) utilizes the backup power supplying device to provide the backup power until all the data stored in the first storage device has been moved to the second storage device.

18. The data backup method of claim 13, further comprising copying the data in the second storage device to the first storage device when the data backup system switches from the second mode to the first mode.

19. A computer readable storage medium including computer program logic encoded thereon that, when executed on a computer system, causes the computer system to produce certified content by performing the operations of:
(a) storing data to a first storage device in a first mode via main power; and
(b) utilizing a backup controller to receive backup power from a backup power supplying device to backup the data stored in the first storage device to a second storage device in a second mode.

20. The computer readable storage medium of claim 19, wherein the first storage device is a storage device that can not keep data without power, and the second storage device is a storage device that can keep data without power.

21. The computer readable storage medium of claim 19, wherein the first mode indicates that the main power is provided to the data backup system, and the second mode indicates that the main power is not provided to the data backup system.

22. The computer readable storage medium of claim 19, wherein the step (b) utilizes the backup power supplying device to provide the backup power only for a predetermined time period in the second mode.

23. The computer readable storage medium of claim 19, wherein the step (b) utilizes the backup power supplying device to provide the backup power until all the data stored in the first storage device has been moved to the second storage device.

24. The computer readable storage medium of claim 19 further comprising performing the step of: copying the data in the second storage device to the first storage device when the computer system switches from the second mode to the first mode.
